(19) United States
(12) Patent Application Publication
(10) Pub. No.: US 2020/0409998 A1
(43) Pub. Date: Dec. 31, 2020

(54) METHOD AND DEVICE FOR OUTPUTTING INFORMATION

(71) Applicant: Beijing Bytedance Network Technology Co., Ltd., Beijing (CN)

(72) Inventors: Dawei CHEN, Beijing (CN); Bao LIU, Beijing (CN)

(21) Appl. No.: 17/020,617

(22) Filed: Sep. 14, 2020

Related U.S. Application Data
(63) Continuation of application No. PCT/CN2018/115950, filed on Nov. 16, 2018.

(30) Foreign Application Priority Data
Aug. 31, 2018 (CN) 201811015354.8

(51) Int. Cl. G06F 16/78; G06F 16/2457; G06F 16/735; G06F 16/738

(52) U.S. Cl. CPC G06F 16/7867; G06F 16/738; G06F 16/735; G06F 16/24578

(57) ABSTRACT

A method for outputting information is provided. The method includes: receiving a search term inputted by a user; matching the search term with attribute information of an entity representing a video in a pre-established knowledge graph, to determine whether a matching entity exists in the knowledge graph, where attribute information of the matching entity matches the search term; in response to determining that there is at least one matching entity, determining, for a matching entity from the determined at least one matching entity and based on an output manner selected by the user, attribute information corresponding to the output manner as target attribute information, where the output manner indicates a ranking order of the target attribute information; and outputting related information of a matching entity corresponding to the target attribute information according to the ranking order of the determined target attribute information.

The present application is a continuation of International Patent Application No. PCT/CN2018/115950 filed on Nov. 16, 2018, which claims priority to Chinese Patent Application No. 201811015354.8, filed on Aug. 31, 2018 with the Chinese Patent Office, both of which are incorporated herein by reference in their entireties.

### FIELD

The present disclosure relates to the technical field of computers, and in particular to a method and a device for outputting information.

### BACKGROUND

Knowledge graph is a knowledge base called semantic network, that is, a knowledge base having a directed graph structure. In which, a node in the graph represents an entity or concept, and an edge in the graph represents various semantic relationships between entities/concepts. The entity may have corresponding attribute information, and the attribute information may be used to represent attributes of the entity (for example, a type of information represented by the entity, and a storage address). The knowledge graph may be applied to various fields, such information search and information recommendation. According to the knowledge graph, other entity related to an entity representing certain information can be obtained, thereby accurately obtaining other information related to the certain information.

### SUMMARY

A method and a device for outputting information are provided according to embodiments of the present disclosure.

In a first aspect, a method for outputting information is provided according to embodiments of the present disclosure. The method includes: receiving a search term inputted by a user; matching the search term with attribute information of an entity representing a video in a pre-established knowledge graph, to determine whether a matching entity exists in the knowledge graph, where the matching entity is an entity of which attribute information matches the search term; in response to determining that there is at least one matching entity, determining, for a matching entity from the determined at least one matching entity and based on an output manner selected by the user, attribute information corresponding to the output manner from attribute information of the matching entity as target attribute information, where the output manner is used to indicate a ranking order of the target attribute information; and outputting related information of a matching entity corresponding to the target attribute information according to the ranking order of the determined target attribution information.

In some embodiments, the attribute information of the entity includes video source information for indicating a source of the video represented by the entity.

In some embodiments, the output manner is further used to indicate the source of the video; and the outputting related information of a matching entity corresponding to the target attribute information according to the ranking order of the determined target attribution information includes: outputting, according to the ranking order of the determined target attribute information, related information of the matching entity corresponding to the target attribute information, for a matching entity of which video source information conforms to the source indicated by the output manner among the at least one matching entity.

In some embodiments, the output manner corresponds to at least one piece of attribute information; and the determining attribute information corresponding to the output manner as the target attribute information includes: determining each of the at least one piece of attribute information corresponding to the output manner as the target attribute information.

In some embodiments, the outputting related information of a matching entity corresponding to the target attribute information according to the ranking order of the determined target attribute information includes: calculating, for a matching entity from the at least one matching entity, a weighted sum of at least one piece of target attribute information of the matching entity, to obtain a calculation result; and outputting, according to a ranking order of the obtained calculation result indicated by the output manner selected by the user, related information of a matching entity corresponding to the calculation result.

In some embodiments, the related information of the matching entity includes at least one of: a title of a video represented by the matching entity, version information of the video represented by the matching entity, a type of the video represented by the matching entity, and related person information of the video represented by the matching entity.

In some embodiments, the target attribute information includes at least one of a video playing amount, a video score and a video attention amount.

In a second aspect, a device for outputting information is provided according to embodiments of the present disclosure. The device includes: a receiving unit, a matching unit, a determining unit and an output unit. The receiving unit is configured to receive a search term inputted by a user. The matching unit is configured to match the search term with attribute information of an entity representing a video in a pre-established knowledge graph, to determine whether a matching entity exists in the knowledge graph, where the matching entity is an entity of which attribute information matches the search term. The determining unit is configured to: in response to determining that there is at least one matching entity, determine, for a matching entity from the determined at least one matching entity and based on an output manner selected by the user, attribute information corresponding to the output manner from attribute information of the matching entity as target attribute information, where the output manner is used to indicate a ranking order of the target attribute information. The output unit is configured to output related information of a matching entity corresponding to the target attribute information according to the ranking order of the determined target attribute information.

In some embodiments, the attribute information of the entity includes video source information for indicating a source of the video represented by the entity.

In some embodiments, the output manner is further used to indicate the source of the video. The output unit is further configured to: output, according to the ranking order of the determined target attribute information, related information of the matching entity corresponding to the target attribute information, for a matching entity of which video source information conforms to the source indicated by the output manner among the at least one matching entity.

In some embodiments, the output manner corresponds to at least one piece of attribute information. The determining unit is further configured to: determine each of the at least one piece of attribute information corresponding to the output manner as the target attribute information.

In some embodiments, the output unit includes: a calculating module and an output module. The calculating module is configured to calculate, for a matching entity from the at least one matching entity, a weighted sum of at least one piece of target attribute information of the matching entity, to obtain a calculation result. The output module is configured to output, according to a ranking order of the obtained calculation result indicated by the output manner selected by the user, related information of a matching entity corresponding to the calculation result.

In some embodiments, the related information of the matching entity includes at least one of: a title of a video represented by the matching entity, version information of the video represented by the matching entity, a type of the video represented by the matching entity, and related person information of the video represented by the matching entity.

In some embodiments, the target attribute information includes at least one of: a video playing amount, a video score and a video attention amount.

In a third aspect, a server is provided according embodiments of the present disclosure. The server includes: one or more processors; and a storage device storing one or more programs. The one or more processors execute the one or more programs to perform the method according to the first aspect described above.

In a fourth aspect, a computer readable storage medium storing a computer program is provided according to embodiments of the present disclosure. A processor executes the computer programs to perform the method according to the first aspect described above.

According to the method and device for outputting information in the embodiments of the present disclosure, the search term inputted by the user is received, and whether a matching entity exists in the pre-established knowledge graph is determined according to the search term. It there exists at least one matching entity, based on an output manner selected by the user, target attribute information corresponding to the output manner is determined from attribute information of the matching entity. Finally, according to a ranking order of the target attribute information, related information of a matching entity corresponding to the target attribute information is outputted, so that related information of the ranked matching entities is outputted, thereby improving pertinence of the outputted information, and thus being beneficial to display related information of the entities to users in a targeted manner.

### BRIEF DESCRIPTION OF THE DRAWINGS

By reading detailed description of non-limiting embodiments of the present disclosure made with reference to the drawings, other features, objects and advantages of the present disclosure will become more apparent.

FIG. 1 is a structural diagram of a schematic system according to an embodiment of the present disclosure:

FIG. 2 is a flowchart of a method for outputting information according to an embodiment of the present disclosure;

FIG. 3 is a schematic diagram of an application scenario of a method for outputting information according to an embodiment of the present disclosure;

FIG. 4 is a flowchart of a method for outputting information according to another embodiment of the present disclosure;

FIG. 5 is a schematic structural diagram of a device for outputting information according to an embodiment of the present disclosure; and

FIG. 6 is a schematic structural diagram of a computer system which adapts to implement a server according to an embodiment of the present disclosure.

### DETAILED DESCRIPTION OF EMBODIMENTS

The present disclosure is described in detail below in conjunction with the drawings and embodiments. It should be understood that, specific embodiments described here are intended to interpret the present disclosure rather than limit the present disclosure. In addition, it should be noted that, only parts related to the present disclosure are shown in the drawings for convenience of description.

It should be noted that, embodiments of the present disclosure and features in the embodiments may be combined with each other without a conflict. The present disclosure is described in detail below in conjunction with embodiments with reference to the drawings.

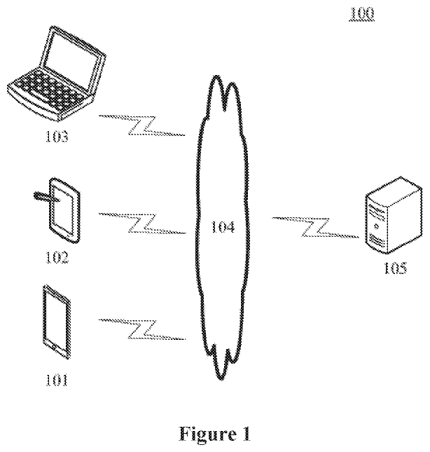

FIG. 1 shows a schematic system architecture 100 applicable to a method for outputting information or a device for outputting information according to an embodiment of the present disclosure.

As shown in FIG. 1, the system architecture 100 may include terminal devices 101, 102, 103, a network 104 and a server 105. The network 104 is used to provide medium of a communication link between the terminal devices 101, 102, 103 and the server 105. The network 104 may include a wired communication link, a wireless communication link or a fiber optic cable and so on.

The user may interact with the server 105 over the network 104 by using the terminal devices 101, 102 and 103, to receive or transmit messages and so on. The terminal device 101, 102 and 103 may be provided with various types of communication client applications, for example data processing type of applications, video playing type of applications, web page browser application, instant communication tool and social platform software.

The terminal devices 101, 102 and 102 may be hardware or software. In a case that that the terminal devices 101, 102 and 103 are hardware, the terminal devices may be electronic devices including but not limited to a smart phone, a tablet computer, a laptop portable computer and a desktop computer. In a case that the terminal devices 101, 102, 103 are software, the terminal devices may be installed in the electronic devices described above. The terminal devices may be implemented as multiple software or software modules (for example software or software modules for providing distributed service), or may be implemented as single software or software module. Specific implementations of the terminal devices are not limited herein.

The serer 105 may be a server providing various types of services, for example, a background information processing server processing search terms sent by the terminal devices 101, 102 and 103. The background information processing server determines a matching entity from entities in a pre-established knowledge graph by using the received search term, and outputs related information of the matching entity.

It should be noted that, the method for outputting information according to the embodiment of the present disclosure is generally performed by the server 105. Accordingly, the device for outputting information is generally provided in the server 105.

It should be noted that, the server may be hardware or software. In a case that the server is hardware, the server may be implemented as a distributed server cluster composed of multiple servers, or may be implemented as a single server. In a case that the server is software, the sever may be implemented as multiple software or software modules (for example, software or software modules for providing a distributed service), or may be implemented as a single software or software module. Specific implementations of the server are not limited herein.

It should be understood that, the numbers of the terminal devices, the network and the server shown in FIG. 1 are only schematic. As required, any number of terminal device, network and server may be provided.

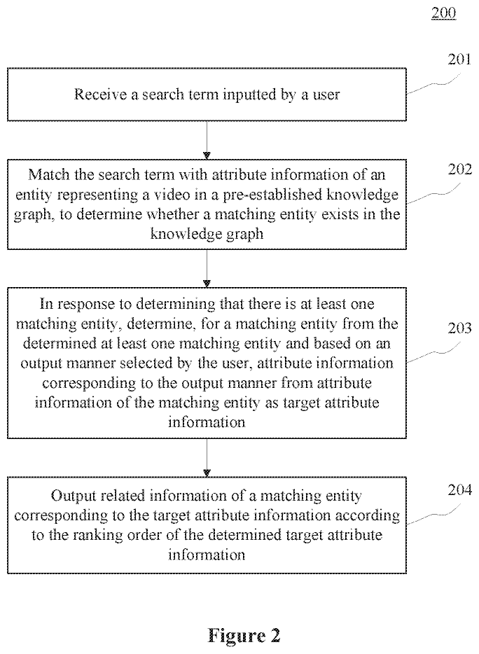

Reference is made to FIG. 2 which shows a flowchart 200 of a method for outputting information according to an embodiment of the present disclosure. The method for outputting information includes steps 201 to 204 in the following.

In step 201, a search term inputted by a user is received.

In the embodiment, an entity (for example the server shown in FIG. 1) performing the method for outputting information may receive the search term inputted by the user in a wired or wireless manner. The number of the search term may be at least one. The search term may be vocabulary, phrase or sentence for information search. The search term may include but not limited to at least one of text of any language (for example Chinese and English), numbers and symbols.

In step 202, the search term is matched with attribute information of an entity representing a video in a pre-established knowledge graph, to determine whether a matching entity exists in the knowledge graph.

In the embodiment, based on the search term received in step 201, the above performing entity may match the search term with the attribute information of the entity representing the video in the pre-established knowledge graph, to determine where a matching entity exists in the knowledge graph. The matching entity is an entity of which attribute information matches the search term.

Generally, the entity in the knowledge graph may be used to represent a certain object or concept (for example persons, locations, time and information). The entity may include at least one of numbers, texts and symbols. In the embodiment, the knowledge graph may include entities representing videos. In an example, a pre-established entity for representing a certain video may be “v-abc”. In which, “v” indicates that the entity is used for representing a video, and “abc” is used to represent an identifier of the video. In addition, the knowledge graph in the embodiment may further include entities representing objects or concepts other than videos. For example, the pre-established entity for representing a certain person may be “p-xyz”. In which, “p” is used to represent a person, and “xyz” is used to represent an identifier of the person.

The entity representing the video may have corresponding attribute information. The attribute information may be information related to the video represented by the entity, and may include but not limited to at least one of: information of persons related to the video (for example video producer, actor and director), information of time related to the video (for example release date and shooting time), source information of the video (a playing address of the video, and a name of a website where the video is located), and other information related to content of the video (for example brief introduction, stage photos and poster pictures of the video). Generally, in the knowledge graph, a relationship between an entity and attribute information may be indicated by a data structure in a form of triple, that is. “entity-attribute-attribute value”. The attribute information of the entity may include the above attribute-attribute value. For example, a triple is “abc123-name-XXX”, in which, “abc123” represents an entity of a movie “XXX”, “name” represents attribute, and “XXX” represents attribute value.

In the embodiment, the performing entity may match the search term with the attribute information of the entity in the knowledge graph in various methods to obtain a matching result. The number of the matching results may be more than one, and each matching result corresponds to one entity in the knowledge graph. For example, the search term includes text. The attribute information of the entity may include text information (for example names of actors, and description of video content). The performing entity may determine, from the entities in the knowledge graph, an entity of which text information included in the attribute information includes the above search term, as the matching entity. It should be noted that, in a case that the number of the search terms is at least one, the performing entity may determine an entity of which text information included in the attribute information includes all or a preset number of search terms among the at least one search term, as the matching entity.

Optionally, the performing entity calculates a similarity between the received search term and the text information included in the attribute information of the entity in the knowledge graph, and determines an entity corresponding to a similarity greater than or equal to a preset similarity threshold as a matching entity matching the search term. Specifically, the performing entity may calculate the similarity between the search term and the text information included in the attribute information of the entity by using the existing algorithms for determining the text similarity (for example Jaccard similarity algorithm, cosine similarity algorithm and simhash algorithm). Optionally, the attribute information of the entity may include at least one keyword. The performing entity may calculate a similarity between the search term and at least one keyword corresponding to the entity as the matching result, by using the existing algorithms for calculating the similarity (for example, Levenshtein Distance algorithm, cosine distance algorithm based on Vector Space Model, VSM).

The performing entity may determine whether a matching entity matching the search term exists in the knowledge graph according to the matching result. As an example, in a case that the matching result is a similarity between the search term and the text information included in the attribute information of the entity in the knowledge graph, an entity corresponding to a similarity greater than or equal to a preset similarity threshold is determined as the matching entity. Generally, the matching entity may indicate videos. The videos may have various forms, for example, a movie, a TV episode and a small video uploaded by the user.

In step 203, in response to determining that there is at least one matching entity, for an entity from the determined at least one matching entity and based on an output manner selected by the user, attribute information corresponding to the output manner is determined from the attribute information of the matching entity, as target attribute information.

In the embodiment, if it is determined that there exists at least one matching entity in the knowledge graph, the performing entity determines, for a matching entity among the determined at least one matching entity and based on an output manner selected by the user, attribute information corresponding to the output manner from the attribute information of the matching entity, as target attribute information. The output manner is further used to indicate a ranking order of the target attribute information.

The output manner may be represented by information which is selectable for the user, and each output manner is set to correspond to at least one type of attribute information in advance. For example, the information representing the output manner may include “playing amount”. In a case that the user selects information “playing amount”, playing amount data of the video represented by the matching entity in a set period is selected from the attribute information of the matching entity, as the target attribute information. In addition, the output manner may further represent a ranking order (for example in a descending order) of the playing amount data. According to this step, each matching entity may correspond to the target attribute information corresponding to the output manner selected by the user, and the ranking order of the target attribute information is determined.

In some optional implementations of the embodiment, the output manner selected by the user corresponds to at least one piece of attribute information. The performing entity may determine each of the at least one piece of attribute information corresponding to the output manner selected by the user, as the target attribute information. According to the embodiment, each matching entity may correspond to at least one piece of attribute information.

In some optional implementations of the embodiment, the target attribute information may include at least one of: a video playing amount, a video score and a video attention amount. The playing amount may be an actual playing amount of the video played in a specified playing platform (for example a certain video website and a certain video playing application) in a specified time period, or may be a ratio of an actual playing amount of video played in the specified playing platform to a total playing amount of the playing platform in the specified time period. The score may be an average value of scores of the video assigned by users. The attention amount may be the number of users paying attention to the video.

In step 204, according to the ranking order of the determined target attribute information, related information of the matching entity corresponding to the target attribute information is outputted.

In the embodiment, the performing entity may output related information of the matching entity corresponding to the target attribute information, according to the ranking order of the determined target attribute information. Generally, the target attribute information may include values, and the ranking order of the target attribute information may be a ranking order of the values. For example, in a case that the target attribute information is a playing amount of a video represented by the matching entity, the performing entity outputs related information of the matching entity corresponding to the target attribute information according to a ranking order of playing amounts corresponding to the matching entities. The related information of the matching entity may be information included in the attribute information of the matching entity, or other information related to the matching entity (for example, pre-acquired comments and scores on the video represented by the matching entity made by the user). In an example, the attribute information may include various types of sub-information. The sub-information may have an identifier or a sequence number to indicate a type of the sub-information. The performing entity may extract sub-information of a preset type from the attribute information as the related information.

Optionally, the performing entity may output the related information of the matching entity in various manners. For example, the related information of the matching entity is displayed on a display device connected to the performing entity according to the order of the target attribute information. Alternatively, according to the order of the target attribute information, the related information of the matching entity is outputted sequentially to other electronic device communicatively connected to the performing entity.

In some optional implementations of the embodiment, the related information of the matching entity may include but not limited to at least one of: a title of the video represented by the matching entity, version information of the video represented by the matching entity (for example, pruning version or “86 version”), a type of the video represented by the matching entity (for example science-fiction, swordsmen), and related person information of the video represented by the matching entity (for example names of an actor, and a director).

In some optional implementations of the embodiment, in a case that the output manner selected by the user corresponds to at least one piece of attribute information, for a matching entity among the at least one matching entity, the performing entity may perform the following operations.

First, a weighted sum of at least one piece of target attribute information of the entity is calculated, to obtain a calculation result. Specifically, a technician may preset a weight for each of the at least one piece of attribute information in the performing entity. Based on the weight for each piece of attribute information, the performing entity may calculate a weighted sum of the target attribute information, to obtain a calculation result. In an example, it is assumed that there are three pieces of target attribute information, that is, a playing amount, a score and an attention amount. The technician may set weights 0.4, 0.3 and 0.3 respectively for the three pieces of target attribute information, and calculates a weighted sum according to 0.4*the playing amount+0.3*the score+0.3*the attention amount.

Then, according to a ranking order of the obtained calculation result indicated by the output manner selected by the user, related information of the matching entity corresponding to the calculation result is outputted. According to the embodiment, an order in which related information of the matching result is outputted may comprehensively embody the target attribute information, thereby being beneficial to improve accuracy of the outputted related information.

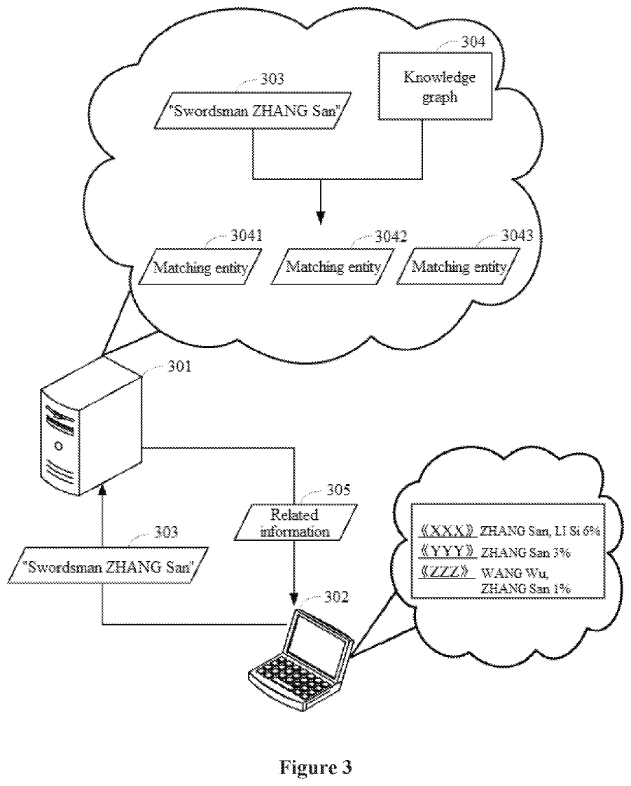

Reference is made to FIG. 3 which shows a schematic diagram of an application scenario of a method for outputting information according to an embodiment of the present disclosure. In an application scenario shown in FIG. 3, a server 301 receives a search term 303 (for example “swordsmen ZHANG San”) inputted by a user through a terminal device 302. Then, the search term 303 is matched with attribute information of an entity representing a video in a pre-established knowledge graph 304, to obtain a matching result corresponding to each entity. The matching result indicates a similarity between the search term 303 and text information included in the attribute information of the entity. Then, the server 301 determines three matching entities 3041, 3042 and 3043 from the knowledge graph 304. A similarity between text information included in the attribute information of each of the matching entities 3041, 3042 and 3043 and the search term 303 is greater than or equal to a preset similarity threshold (for example 90%). Then, the server 301 determines the target attribute information corresponding to the output manner selected by the user as a playing amount of the video represented by the entity at a current day, and the output manner is used to indicate a descending order of the playing amount. Finally, the server 301 outputs related information 305 of the matching entity to a display device connected to the server 301 for displaying, according to the descending order of the playing amount. The related information of the matching entities 3041, 3042 and 3043 is titles of the videos represented by the matching entities (for example “XXX”, “YYY” and “ZZZ”), names of actors (for example “ZHANG San, LI Si”. “ZHANG San”, “WANG Wu, ZHANG San”), and playing amounts (for example “6%, “3%” and “1%”). The playing amount indicates a ratio of an actual playing amount of the matching entity in a certain playing platform and a total playing amount of the playing platform.

According to the method in the embodiments of the present disclosure, the search term inputted by the user is received, and whether a matching entity exists in the pre-established knowledge graph is determined according to the search term. It there exists at least one matching entity, based on an output manner selected by the user, target attribute information corresponding to the output manner is determined from attribute information of the matching entity. Finally, according to a ranking order of the target attribute information, related information of a matching entity corresponding to the target attribute information is outputted, so that related information of the ranked matching entities is outputted, thereby improving pertinence of the outputted information, and thus being beneficial to display related information of the entities to users in a targeted manner.

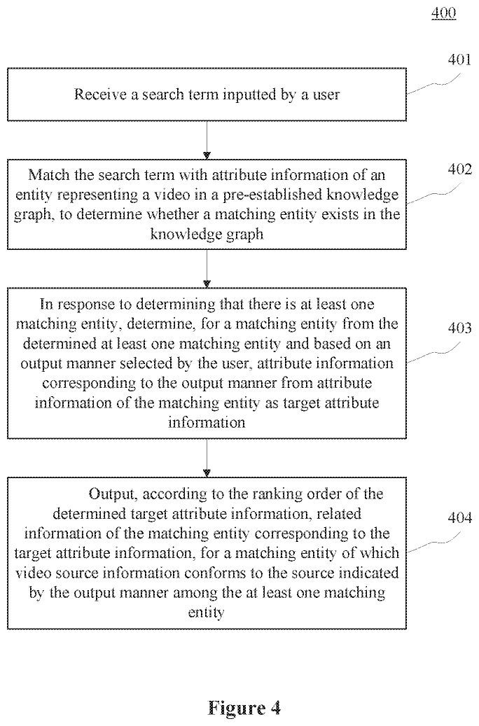

Reference is made to FIG. 4 which shows a flowchart 400 of a method for outputting information according to another embodiment of the present disclosure. The method for outputting information includes steps 401 to 404 in the following.

In step 401, a search term inputted by a user is received.

In the embodiment, step 401 is substantially consistent with step 201 in the embodiment corresponding to FIG. 2. Details are not repeated herein.

In step 402, the search term is matched with attribute information of an entity representing a video in a pre-established knowledge graph, to determine whether a matching entity exists in the knowledge graph.

In the embodiment, attribute information of the entity may include video source information for indicating a source of the video represented by the entity (such as, a playing address and a storage address for the video).

The process of determining whether a matching entity exists in the knowledge graph in this step is substantially consistent with the process of determining whether a matching entity exists in the knowledge graph described in step 202. Details are not repeated herein.

In step 403, in response to determining that there is at least one matching entity, for a matching entity from the determined at least one matching entity and based on an output manner selected by the user, attribute information corresponding to the output manner is determined from the attribute information of the matching entity, as target attribute information.

In the embodiment, step 403 is substantially consistent with step 203 in the embodiment corresponding to FIG. 2. Details are not repeated herein.

In step 404, for a matching entity of which video source information conforms to the source indicated by the output manner among the at least one matching entity, related information of the matching entity corresponding to the target attribute information is outputted according to the ranking order of the determined target attribute information.

In the embodiment, the performing entity may output, for a matching entity of which video source information conforms to the source indicted by the output manner among the at least one matching entity, related information of the matching entity corresponding to the target attribute information according to the ranking order of the determined target attribute information. The output manner selected by the user may indicate the source of the video. For example, the output manner selected by the user indicates that a source of the video is a certain video playing website. The performing entity determines, from the at least one matching entity, a matching entity, where a source of a video represented by the matching entity is the video playing website. According to a ranking order of target attribute information of the determined matching entities, related information of the matching entity corresponding to the target attribute information is outputted.

It should be noted that, the related information of the matching entity in this step may be the same as the related information described in step 204. Details are not described herein.

Compared with the embodiment corresponding to FIG. 2, according to the embodiment shown FIG. 4, the method for outputting information includes: determining the matching entity according to the video source information. It follows that, with the solution described in the embodiment, it is beneficial for the user to select to output related information of the video from certain sources, thereby improving pertinence of information output.

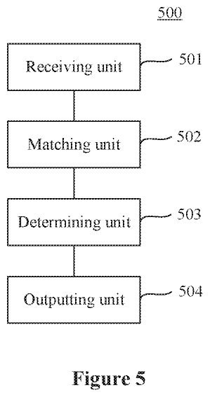

As shown in FIG. 5, a device for outputting information is provided according to an embodiment of the present disclosure to implement the method shown in the above drawings. The device embodiment corresponds to the method embodiment shown in FIG. 2, and the device may be applied into various electronic apparatus.

As shown in FIG. 5, a device 500 for outputting information according to the embodiment includes: a receiving unit 501, a matching unit 502, a determining unit 503 and an outputting unit 504. The receiving unit 501 is configured to receive a search term inputted by a user. The matching unit 502 is configured to match the search term with attribute information of an entity representing a video in a pre-established knowledge graph, to determine whether a matching entity exists in the knowledge graph. The matching entity is an entity of which attribute information matches the search term. The determining unit 503 is configured to determine, in response to determining that there is at least one matching entity, for a matching entity from the determined at least one matching entity and based on an output manner selected from the user, attribute information corresponding to the output manner from the attribute information of the matching entity, as target attribute information. The output manner is further used to indicate a ranking order of the target attribute information. The output unit 504 is configured to output related information of the matching entity corresponding to the target attribute information, according to the ranking order of the determined target attribute information.

In the embodiment, the receiving unit 501 may receive the search term inputted by the user in a wired or wireless manner. The number of the search term may be at least one. The search term may be vocabulary, phrase or sentence for information search. The search term may include but not limited to at least one of: text in any language (for example Chinese and English), numbers and symbols.

In the embodiment, based on the search term received by the receiving unit 501, the matching unit 502 matches the search term with attribute information of an entity representing a video in a pre-established knowledge graph, to determine whether a matching entity exists in the knowledge graph. The matching entity is an entity of which attribute information matches the search term.

Generally, the entity in the knowledge graph may be used to represent a certain object or concept (for example persons, locations, time and information). The entity may include at least one of numbers, texts and symbols. In the embodiment, the knowledge graph may include entities representing videos. In an example, a pre-established entity for representing a certain video may be “v-abc”. In which, “v” indicates that the entity is used for representing a video, and “abc” is used to represent an identifier of the video. In addition, the knowledge graph in the embodiment may further include entities representing objects or concepts other than videos. For example, the pre-established entity for representing a certain person may be “p-xyz”. In which, “p” is used to represent a person, and “xyz” is used to represent an identifier of the person.

The entity representing the video may have corresponding attribute information. The attribute information may be information related to the video represented by the entity, and may include but not limited to at least one of: information of persons related to the video (for example video producer, actor and director), information of time related to the video (for example release date and shooting time), source information of the video (a playing address of the video, and a name of a website where the video is located), and other information related to content of the video (for example brief introduction, stage photos and poster pictures of the video). Generally, in the knowledge graph, a relationship between an entity and attribute information may be indicated by a data structure in a form of triple, that is, “entity-attribute-attribute value”. The attribute information of the entity may include the above attribute-attribute value. For example, a triple is “abc123-name-XXX”, in which, “abc123” represents an entity of a movie “XXX”, “name” represents attribute, and “XXX” represents attribute value.

In the embodiment, the matching unit 502 may match the search term with attribute information of the entity in the knowledge graph by using various methods to obtain a matching result. The number of the matching results may be more than one. Each matching result corresponds to one entity in the knowledge graph. For example, the search term includes text. The attribute information of the entity may include text information (for example names of actors, and description on the video content). The matching unit 502 may determine, from the entities in the knowledge graph, an entity of which text information included in the attribute information includes the search term, as the matching entity. It should be noted that, in a case that the number of the search term is at least one, the matching unit 502 may determine an entity of which text information included in the attribute information includes all or a preset number of search term among the at least one search term, as the matching entity.

The matching unit 502 may determine whether a matching entity matching the search term exists in the knowledge graph according to the matching result. In an example, in a case that the matching result is a similarity between the search term and the text information included in the attribute information of the entity in the knowledge graph, an entity corresponding to a similarity greater than or equal to a preset similarity threshold may be determined as the matching entity. Generally, the matching entity may indicate videos. The video may include for example a movie, a TV episode and a small video uploaded by the user.

In the embodiment, if it is determined that there exists at least one matching entity in the knowledge graph, the determining unit 503 determines, for a matching entity among the determined at least one matching entity and based on an output manner selected by the user, attribute information corresponding to the output manner from the attribute information of the matching entity, as target attribute information. The output manner is further used to indicate a ranking order of the target attribute information.

The output manner may be represented by information which is selectable for the user, and each output manner is set to correspond to at least one type of attribute information in advance. For example, the information representing the output manner may include “playing amount”. In a case that the user selects information “playing amount”, playing amount data of the video represented by the matching entity in a set period is selected from the attribute information of the matching entity, as the target attribute information. In addition, the output manner may further represent a ranking order (for example in a descending order) of the playing amount data. According to this step, each matching entity may correspond to the target attribute information corresponding to the output manner selected by the user.

In the embodiment, the output unit 504 may output related information of the matching entity corresponding to the target attribute information, according to the ranking order of the determined target attribute information. Generally, the target attribute information may include a value. The ranking order of the target attribute information may be a ranking order of values. For example, in a case that the target attribute information is a playing amount of the video represented by the matching entity, the output unit 504 may output related information of the matching entity corresponding to the target attribute information according to the ranking order of the playing amounts corresponding to the matching entities. The related information of the matching entity may be information included in the attribute information of the matching entity, or may be other information related to the matching entity (for example, pre-acquired comments and scores on the video represented by the matching entity made by the user). In an example, the attribute information may include various types of sub-information. The sub-information may have an identifier or a sequence number to indicate a type of the sub-information. The output unit 504 may extract sub-information of a preset type from the attribute information, as related information.

Optionally, the output unit 504 may output related information of the matching entity in various methods. For example, the related information of the matching entity is displayed on a display device connected to the device 500 according to an order of the target attribute information. Alternatively, according to the order of the target attribute information, the related information of the matching entity is outputted sequentially to other electronic device communicatively connected to the above device 500.

In some optional implementations of the embodiment, the attribute information of the entity may include video source information. The video source information is used to indicate a source of the video represented by the entity.

In some optional implementations of the embodiment, the output manner is further used to indicate the source of the video. The output unit 504 may be further configured to, for a matching entity of which video source information conforms to the source indicated by the output manner among the at least one matching entity, output related information of the matching entity corresponding to the target attribute information according to the ranking order of the determined target attribute information.

In some optional implementations of the embodiment, the output manner corresponds to at least one piece of attribute information. The determining unit 503 may be further configured to determine each of the at least one piece of attribute information corresponding to the output manner as the target attribute information.

In some optional implementations of the embodiment, the output unit 504 may include: a calculation module (not shown) and an output module (not shown). The calculation module is configured to calculate, for a matching entity from the at least one matching entity, a weighted sum of at least one piece of target attribute information of the entity, to obtain a calculation result. The output module is configured to output related information of the matching entity corresponding to the calculation result, according to a ranking order of the obtained calculation results indicated by the output manner selected by the user.

In some optional implementations of the embodiment, the related information of the matching entity may include at least one of: a title of the video represented by the matching entity, version information of the video represented by the matching entity, a type of the video represented by the matching entity, and related person information of the video represented by the matching entity.

In some optional implementations of the embodiment, the target attribute information may include at least one of: a video playing amount, a video score and a video attention amount.

According to the device in the embodiments of the present disclosure, the search term inputted by the user is received, and whether a matching entity exists in the pre-established knowledge graph is determined according to the search term. If there exists at least one matching entity, based on an output manner selected by the user, target attribute information corresponding to the output manner is determined from attribute information of the matching entity. Finally, according to a ranking order of the target attribute information, related information of a matching entity corresponding to the target attribute information is outputted, so that related information of the ranked matching entities is outputted, thereby improving pertinence of the outputted information, and thus being beneficial to display related information of the entities to users in a targeted manner.

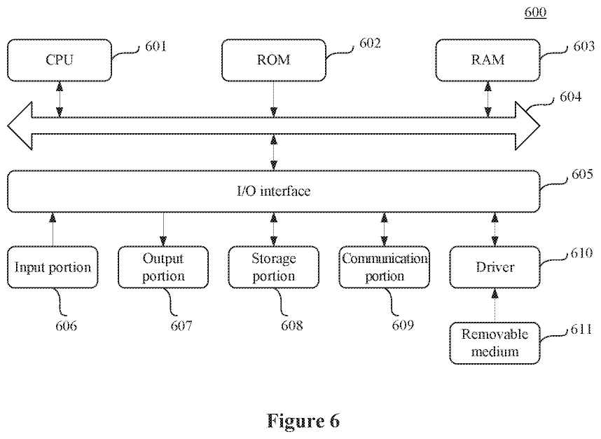

Reference is made to FIG. 6 which shows a schematic structural diagram of a computer system 600 which adapts to implement the server according to the embodiment of the present disclosure. The server 6 shown in FIG. 6 is only schematic, and is not intended to limit the functions and usage scope of the embodiments of the present disclosure in any manner.

As shown in FIG. 6, the computer system 600 includes a central processing unit (CPU) 601. The CPU 601 may perform various suitable actions and processing according to programs stored in a read only memory (ROM) 602, or programs loaded to a random access memory (RAM) 603 from a storage portion 608. In the RAM 603, various types of programs required by operation of the system 600 and data are also stored. The CPU 601, the ROM 602 and the RAM 603 are connected to each other via a bus 604. An input/output (1/O) interface 605 is also connected to the bus 604.

The following components are connected to the I/O interface 605; an input portion 606 including a keyboard and a mouse and so on; an output portion 607 including a cathode ray tube (CRT), a liquid crystal display (LCD) and a loudspeaker; a storage portion 608 including a hard disk; and a communication portion 609 including a network interface card such as a LAN card and a modem. The communication portion 609 performs communication processing over a network such as the Internet. A driver 610 is connected to the I/O interface 605 as needed. A removable medium 611, for example a magnetic disk, an optical disk, a magnetic-optical disk and a semiconductor memory, is installed in the driver 610 as needed, so that computer programs read from the driver 610 is installed in the storage portion 608 as needed.

Particularly, according to the embodiment of the present disclosure, the process described with reference to the flowchart above may be implemented as computer software programs. For example, a computer program product is provided according to embodiments of the present disclosure. The computer program product includes computer programs carried on a computer readable medium, and the computer programs include program codes for performing the method shown in the flowchart. In such embodiment, the computer program may be loaded and installed from the network through the communication portion 609, and/or is installed from the removable medium 611. When the computer program is implemented by the central processing unit (CPU) 601, the functions defined in the method according to the present disclosure are performed.

It should be noted that, the computer readable medium described in the present disclosure may be a computer readable signal medium or a computer readable medium or a combination thereof. The computer readable medium may be but not limited to, electrical, magnetic, optical, electromagnetic, infrared or semiconductor systems, apparatus or devices, or a combination thereof. The computer readable medium may include but not limited to: electrical connection having one or more wires, a portable computer magnetic disk, a hard disk, a random access memory (RAM), a read only memory (ROM), an erasable programmable read only memory (EPROM or a flash memory), a fiber optic, a portable compact disc read only memory (CD-ROM), an optical storage device, a magnetic storage device, or a suitable combination thereof. In the present disclosure, the computer readable medium may be any tangible medium including or storing programs. The programs may be used by an instruction execution system, an apparatus, a device or a combination thereof. In the present disclosure, the computer readable signal medium may include a data signal in a baseband or a data signal propagated as a part of a carrier. The data signal carries the computer readable program codes. The propagated data signal may include but not limited to an electromagnetic signal, an optical signal or a suitable combination thereof. The computer readable signal medium may be any computer readable medium other than the computer readable medium. The computer readable medium may send, propagate or transmit the programs used by the instruction performing system, the apparatus, the device or a combination thereof. The program codes included in the computer readable medium may be transmitted by any suitable medium, including but not limited to: wireless, wired, optical cable, RF or a suitable combination thereof.

Computer program codes for performing operations of the present disclosure may be written by using one or more types of program design languages or a combination thereof. The program design language includes: object-oriented program design language such as Java, Smalltalk and C++; and conventional process program design language such as “C” language or similar program design language. The program codes may be completely or partially executed by a user computer, or executed as an independent software package. Alternatively, a part of the program codes is executed by a user computer, another part of the program codes is executed by a remote computer, or all of the program codes are executed by the remote computer or a server. The remote computer may be connected to the user computer over any type of network including local area network (LAN) and wide area network (WAN), or may be connected to an external computer (for example connecting over the Internet provided by the Internet service provider).

The flowcharts and block diagrams in the drawings show system architectures, functions and operations which may be implemented by the system, method and computer program product according to the embodiments of the present disclosure. Each block in the flowchart or block diagram may represent a module, a program segment or a part of codes. The module, the program section or the part of codes includes one or more executable instructions for implementing specified logical functions. It should be noted that, in an alternative embodiment, functions marked in the blocks may be performed in an order different from an order marked in the drawings. For example, depending on the involved functions, operations in two connected blocks may be performed substantially in parallel, or may be performed in an opposite order. It should be noted that, each block in the block diagrams and/or the flowcharts and a combination of blocks in the block diagram and/or the flowcharts may be implemented by a dedicated system based on hardware performing specified functions or operations, or may be implemented by a combination of dedicated hardware and computer instructions.

Units involved in the embodiments of the present disclosure may be implemented by software or hardware. The described units may be arranged in a processor. For example, a processor includes a receiving unit, a matching unit, a determining unit and an output unit. Names of the units are not intended to limit the units themselves in some cases. For example, the receiving unit may be interpreted as a unit receiving a search term inputted by a user.

In another aspect, a computer readable medium is further provided according to the present disclosure. The computer readable medium may be included in the server described in the above embodiments, or may be independent from the server. The computer readable medium carries one or more programs. The one or more programs are executed by the server, to cause the server to: receive a search term inputted by a user; match the search term with attribute information of an entity representing a video in a pre-established knowledge graph, to determine whether a matching entity exists in the knowledge graph, where the matching entity is an entity of which attribute information matches the search term; and in response to determining that there is at least one matching entity, determine, for a matching entity from the determined at least one matching entity and based on an output manner selected by a user, attribute information corresponding to the output manner from attribute information of the matching entity, as target attribute information, where the output manner is further used to indicate a ranking order of target attribute information; and output related information of the matching entity corresponding to the target attribute information according to the ranking order of the determined target attribute information.

Preferred embodiments of the present disclosure and principles of the technology applied in the present disclosure are described above. Those skilled in the art should understand that the present disclosure not only includes the technical solutions formed by specific combinations of the above technical features, but also include other technical solutions formed by any combination of the above technical features or their equivalent features without departing from the concept of the present disclosure, for example, the technical solutions formed by exchanging the above technical features with the technical features having similar functions disclosed (not limited) by the present disclosure.

1. A method for outputting information, comprising:
receiving a search term inputted by a user;
matching the search term with attribute information of an entity representing a video in a pre-established knowledge graph, to determine whether a matching entity exists in the knowledge graph, wherein the matching entity is an entity of which attribute information matches the search term;
in response to determining that there is at least one matching entity, determining, for a matching entity from the determined at least one matching entity and based on an output manner selected by the user, attribute information corresponding to the output manner from attribute information of the matching entity as target attribute information, wherein the output manner is used to indicate a ranking order of the target attribute information; and
outputting related information of a matching entity corresponding to the target attribute information according to the ranking order of the determined target attribute information.

2. The method according to claim 1, wherein the attribute information of the entity comprises video source information for indicating a source of the video represented by the entity.

3. The method according to claim 2, wherein the output manner is further used to indicate the source of the video;
and wherein the outputting related information of a matching entity corresponding to the target attribute information according to the ranking order of the determined target attribute information comprises:
outputting, according to the ranking order of the determined target attribute information, related information of the matching entity corresponding to the target attribute information, for a matching entity of which video source information conforms to the source indicated by the output manner among the at least one matching entity.

4. The method according to claim 1, wherein the output manner corresponds to at least one piece of attribute information:
and wherein the determining attribute information corresponding to the output manner as the target attribute information comprises:
determining each of the at least one piece of attribute information corresponding to the output manner as the target attribute information.

5. The method according to claim 4, wherein the outputting related information of a matching entity corresponding to the target attribute information according to the ranking order of the determined target attribute information comprises:
calculating, for a matching entity from the at least one matching entity, a weighted sum of at least one piece of target attribute information of the matching entity, to obtain a calculation result; and
outputting, according to a ranking order of the obtained calculation result indicated by the output manner selected by the user, related information of a matching entity corresponding to the calculation result.

6. The method according to claim 1, wherein the related information of the matching entity comprises at least one of: a title of a video represented by the matching entity, version information of the video represented by the matching entity, a type of the video represented by the matching entity, and related person information of the video represented by the matching entity.

7. The method according to claim 1, wherein the target attribute information comprises at least one of: a video playing amount, a video score and a video attention amount.

8. A device for outputting information, comprising:
one or more processors; and
a storage device storing one or more programs,
wherein the one or more processors execute the one or more programs to perform to:
receive a search term inputted by a user;
match the search term with attribute information of an entity representing a video in a pre-established knowledge graph, to determine whether a matching entity exists in the knowledge graph, wherein the matching entity is an entity of which attribute information matches the search term;
in response to determining that there is at least one matching entity, determine, for a matching entity from the determined at least one matching entity and based on an output manner selected by the user, attribute information corresponding to the output manner from attribute information of the matching entity as target attribute information, wherein the output manner is used to indicate a ranking order of the target attribute information; and
output related information of a matching entity corresponding to the target attribute information according to the ranking order of the determined target attribute information.

9. The device according to claim 8, wherein the attribute information of the entity comprises video source information for indicating a source of the video represented by the entity.

10. The device according to claim 9, wherein the output manner is further used to indicate the source of the video;
and wherein the one or more processors execute the one or more programs to perform to:
output, according to the ranking order of the determined target attribute information, related information of the matching entity corresponding to the target attribute information, for a matching entity of which video source information conforms to the source indicated by the output manner among the at least one matching entity.

11. The device according to claim 8, wherein the output manner corresponds to at least one piece of attribute information;
and wherein the one or more processors execute the one or more programs to perform to:
determine each of the at least one piece of attribute information corresponding to the output manner as the target attribute information.

12. The device according to claim 11, wherein the one or more processors execute the one or more programs to perform to:
calculate, for a matching entity from the at least one matching entity, a weighted sum of at least one piece of target attribute information of the matching entity, to obtain a calculation result; and
output, according to a ranking order of the obtained calculation result indicated by the output manner selected by the user, related information of a matching entity corresponding to the calculation result.

13. The device according to claim 8, wherein the related information of the matching entity comprises at least one of: a title of a video represented by the matching entity, version information of the video represented by the matching entity, a type of the video represented by the matching entity, and related person information of the video represented by the matching entity.

14. A non-transitory computer readable medium storing computer programs, wherein a processor executes the programs to perform operations of:
receiving a search term inputted by a user;
matching the search term with attribute information of an entity representing a video in a pre-established knowledge graph, to determine whether a matching entity exists in the knowledge graph, wherein the matching entity is an entity of which attribute information matches the search term;
in response to determining that there is at least one matching entity, determining, for a matching entity from the determined at least one matching entity and based on an output manner selected by the user, attribute information corresponding to the output manner from attribute information of the matching entity as target attribute information, wherein the output manner is used to indicate a ranking order of the target attribute information; and
outputting related information of a matching entity corresponding to the target attribute information according to the ranking order of the determined target attribute information.

15. The non-transitory computer readable medium according to claim 14, wherein the attribute information of the entity comprises video source information for indicating a source of the video represented by the entity.

16. The non-transitory computer readable medium according to claim 15, wherein the output manner is further used to indicate the source of the video:
and wherein the processor executes the programs to perform operations of:
outputting, according to the ranking order of the determined target attribute information, related information of the matching entity corresponding to the target attribute information, for a matching entity of which video source information conforms to the source indicated by the output manner among the at least one matching entity.

17. The non-transitory computer readable medium according to claim 14, wherein the output manner corresponds to at least one piece of attribute information;
and wherein the processor executes the programs to perform operations of:
determining each of the at least one piece of attribute information corresponding to the output manner as the target attribute information.

18. The non-transitory computer readable medium according to claim 17, wherein the processor executes the programs to perform operations of:
calculating, for a matching entity from the at least one matching entity, a weighted sum of at least one piece of target attribute information of the matching entity, to obtain a calculation result; and
outputting, according to a ranking order of the obtained calculation result indicated by the output manner selected by the user, related information of a matching entity corresponding to the calculation result.
